(19) United States
(12) Patent Application Publication
(10) Pub. No.: US 2021/0122162 A1
(43) Pub. Date: Apr. 29, 2021

(54) LIQUID ABSORPTION SYSTEM, LIQUID ABSORPTION UNIT, AND IMAGE FORMING APPARATUS

(71) Applicant: SEIKO EPSON CORPORATION, Tokyo (JP)

(72) Inventor: Shigemi WAKABAYASHI, Shiojiri (JP)

(21) Appl. No.: 17/076,942

(22) Filed: Oct. 22, 2020

(30) Foreign Application Priority Data
Oct. 24, 2019 (JP) 2019-193293

(51) Int. Cl. B41J 2/165

(52) U.S. Cl. CPC B41J 2/1652

(57) ABSTRACT

A liquid absorption system includes a pipe which transports a liquid containing an organic solvent; a discharge portion which discharges the liquid transported by the pipe; a container which recovers the liquid discharged from the discharge portion; an absorbing portion which is received in the container and which includes a polymer absorbent absorbing the liquid; and an organic solvent adsorbing portion which adsorbs the organic solvent contained in the liquid, and the organic solvent adsorbing portion is provided at a position at which the organic solvent adsorbing portion comes in contact with the liquid before the liquid comes in contact with the absorbing portion.

The present application is based on, and claims priority from JP Application Serial Number 2019-193293, filed Oct. 24, 2019, the disclosure of which is hereby incorporated by reference herein in its entirety.

### BACKGROUND

### 1. Technical Field

The present disclosure relates to a liquid absorption system, a liquid absorption unit, and an image forming apparatus.

### 2. Related Art

In an ink jet printer, for example, when a head cleaning operation is performed in order to prevent degradation in printing quality due to ink clogging, and/or when an ink filling operation is performed after ink cartridge exchange, a waste ink is generated. In order to absorb the waste ink as described above, the ink jet printer includes a liquid absorber containing a liquid absorbent.

For example, JP-A-2007-8126 has discloses a waste ink absorbent containing a water absorbing polymer. According to the waste ink absorbent as described above, a waste ink is absorbed by the water absorbing polymer, and at the same time, the waste ink thus absorbed is retained.

However, the waste ink absorbent disclosed in JP-A-2007-8126 has been considered assuming that a pigment ink is mainly used. On the other hand, a dye ink contains a relatively large amount of an organic solvent as compared to that of the pigment ink, and when the dye ink is absorbed in the waste ink absorbent disclosed in JP-A-2007-8126, an absorption amount is disadvantageously decreased in some cases. Hence, while waste liquid retention characteristics by a water absorbing polymer is utilized, a liquid absorption system which is also used for the dye ink has been desired to be developed.

### SUMMARY

According to an aspect of the present disclosure, there is provided a liquid absorption system comprising: a pipe which transports a liquid containing an organic solvent; a discharge portion which discharges the liquid transported by the pipe; a container which recovers the liquid discharged from the discharge portion; an absorbing portion which is received in the container and which includes a polymer absorbent absorbing the liquid; and an organic solvent adsorbing portion which adsorbs the organic solvent contained in the liquid, and the organic solvent adsorbing portion is provided at a position at which the organic solvent adsorbing portion comes in contact with the liquid before the liquid comes in contact with the absorbing portion.

According to another aspect of the present disclosure, there is provided a liquid absorption unit comprising: a container which recovers a liquid containing an organic solvent introduced from an introduction portion configured to introduce the liquid; an absorbing portion which is received in the container and which includes a polymer absorbent absorbing the liquid; and an organic solvent adsorbing portion which is received in the container and which adsorbs the organic solvent contained in the liquid, and the organic solvent adsorbing portion is provided at a position at which the organic solvent adsorbing portion comes in contact with the liquid before the liquid comes in contact with the absorbing portion.

According to another aspect of the present disclosure, there is provided an image forming apparatus comprising: the liquid absorption system according to the present disclosure or the liquid absorption unit according to the present disclosure.

### BRIEF DESCRIPTION OF THE DRAWINGS

FIG. 1 is a partially vertical cross-sectional view showing an image forming apparatus and a liquid absorption system according to a first embodiment.

FIG. 2 is a view illustrating a small piece which forms an absorbing portion in FIG. 1.

FIG. 3 is a view illustrating the small piece which forms the absorbing portion in FIG. 1.

FIG. 4 is an enlarged cross-sectional view of an organic solvent adsorbing portion shown in FIG. 1.

FIG. 5 is a view illustrating a method for manufacturing the absorbing portion of the liquid absorption system shown in FIG. 1.

FIG. 6 is a view illustrating the method for manufacturing the absorbing portion of the liquid absorption system shown in FIG. 1.

FIG. 7 is a view illustrating the method for manufacturing the absorbing portion of the liquid absorption system shown in FIG. 1.

FIG. 8 is a partially vertical cross-sectional view showing a liquid absorption system according to a second modified example.

FIG. 9 is a partially vertical cross-sectional view showing a liquid absorption system according to a third modified example.

FIG. 10 is a partially vertical cross-sectional view showing a liquid absorption unit according to a second embodiment.

FIG. 11 is a horizontal cross-sectional view of the liquid absorption unit shown in FIG. 10.

FIG. 12 is a partially vertical cross-sectional view showing a liquid absorption unit according to a fourth modified example.

### DESCRIPTION OF EXEMPLARY EMBODIMENTS

Hereinafter, a liquid absorption system, a liquid absorption unit, and an image forming apparatus according to the present disclosure will be described in detail with reference to embodiments shown in the attached drawings.

### 1. First Embodiment

First, an image forming apparatus and a liquid absorption system according to a first embodiment will be described.

### 1.1 Image Forming Apparatus

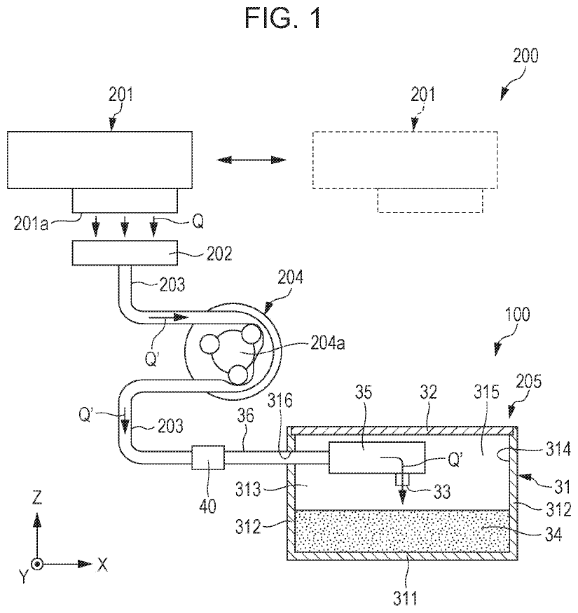

FIG. 1 is a partially vertical cross-sectional view showing the image forming apparatus and the liquid absorption system according to the first embodiment. In addition, in each drawing of the present disclosure, as three axes orthogonal to each other, an X axis, a Y axis, and a Z axis are set. In addition, the axes are each represented by an arrow, and a front end side and a base end side of the arrow are called “plus side” and “minus side”, respectively, of each axis. In addition, the Z-axis plus side and the Z-axis minus side are called “upper side” and “lower side”, respectively.

An image forming apparatus 200 shown in FIG. 1 is, for example, an ink jet type color printer. This image forming apparatus 200 includes a liquid absorption system 100 which recovers a waste liquid Q′ of an ink Q which is one example of a liquid.

The image forming apparatus 200 includes an ink ejection head 201 which ejects the ink Q, a capping unit 202 which prevents clogging of nozzles 201a of the ink ejection head 201, a tube 203 which couples the capping unit 202 and the liquid absorption system 100, a roller pump 204 which transports the ink Q from the capping unit 202, and a recovery portion 205.

The ink ejection head 201 has a plurality of nozzles 201a which eject the ink Q to the lower side. This ink ejection head 201 is able to perform printing by ejecting the ink Q while being transferred with respect to a recording medium, such as paper.

When the ink ejection head 201 is placed at a waiting position, by an operation of the roller pump 204, the capping unit 202 collectively sucks all the nozzles 201a. Accordingly, the ink Q is sucked from all the nozzles 201a, and the clogging of the nozzles 201a can be prevented.

The tube 203 is a pipe line which guides the ink Q sucked through the capping unit 202 to the liquid absorption system 100. This tube 203 has flexibility.

The roller pump 204 is disposed on the way of the tube 203 and has a rotatable roller portion 204a. Since the roller portion 204a rotates, the tube 203 is pressed, and a vacuum state is partially formed; hence, a suction force is generated in the capping unit 202. In addition, since the roller portion 204a continuously rotates, an ink Q which is adhered to the nozzles 201a can be transported to the recovery portion 205.

The recovery portion 205 includes a container 31, a pipe 36 which couples the tube 203 and the container 31, and an absorbing portion 34 received in the container 31. The ink Q is transported to the recovery portion 205 and is recovered as the waste liquid Q′.

As the ink Q, for example, there may be mentioned an aqueous ink in which a colorant is dissolved in an aqueous solvent, a solvent-based ink in which a binder is dissolved in a solvent, an UV curable ink in which a binder is dissolved in an liquid-phase monomer to be cured by UV (Ultra Violet) radiation, or a latex ink in which a binder is dispersed in a dispersion medium. Among those inks mentioned above, for example, a dye ink contains, besides an organic solvent, a dye, and the like, water as a primary component.

In addition, as described above, in this embodiment, by the recovery portion 205, the liquid absorption system 100 is formed. Although the liquid absorption system 100 according to this embodiment absorbs the waste liquid Q′ of the ink Q, the liquid absorbed by the liquid absorption system 100 is not limited to the waste liquid Q′ of the ink Q, and other various types of liquids may also be absorbed.

### 1.2 Liquid Absorption System

The liquid absorption system 100 shown in FIG. 1 includes the pipe 36, a discharge portion 33 which discharges the waste liquid Q′, the container 31, the absorbing portion 34, and an organic solvent adsorbing portion 35.

### 1.2.1 Pipe

The pipe 36 is coupled to the tube 203 with a connection portion 40 shown in FIG. 1 interposed therebetween. Accordingly, the waste liquid Q′ sucked through the tube 203 is transported to the pipe 36. In addition, the pipe 36 is coupled to the discharge portion 33 through the organic solvent adsorbing portion 35 which will be described later. Hence, the waste liquid Q′ transported to the pipe 36 is further transported to the discharge portion 33 through the organic solvent adsorbing portion 35. In addition, in the following description, a discharge portion 33 side and a tube 203 side of the pipe 36 are called “downstream” and “upstream”, respectively.

The connection portion 40 is a joint which couples the tube 203 and the pipe 36. The connection portion 40 may be configured to freely disengage the connection state between the tube 203 and the pipe 36, if needed. Accordingly, the liquid absorption system 100 may be fitted to or detached from a main body of the image forming apparatus 200. Hence, for example, when an absorption amount of the waste liquid Q′ reaches the limit of the liquid absorption system 100, an exchange operation for a new liquid absorption system 100 may be easily performed.

### 1.2.2 Container

The container 31 has a box shape having an approximately rectangular bottom portion 311 when viewed in plan from the above and four side wall portions 312 standing from the sides of the bottom portion 311 to the upper side. In addition, in a receiving space 313 surrounded by the bottom portion 311 and the four side wall portions 312, the absorbing portion 34 is received.

In addition, the container 31 is not limited to a container having an approximately rectangular bottom portion 311 when viewed in plan and may be, for example, a container having a round-shaped bottom portion 311 when viewed in plan and a cylindrical shape as a whole, and the bottom portion 311 may also have a polygonal shape or a shape different therefrom when viewed in plan.

Although the container 31 may have flexibility, the container 31 is preferably rigid. The rigid container 31 indicates a container having a rigidity such that its volume is not changed by 10% or more when an inside pressure or an outside pressure is applied thereto. The container 31 as described above is able to retain the shape thereof even when after the absorbing portion 34 absorbs the waste liquid Q′, a force generated by the expansion is applied to the container 31 from the inside. Accordingly, the installation state of the container 31 is stabilized in the image forming apparatus 200.

Although a constituent material of the container 31 is not particularly limited as long as not allowing the ink Q to pass therethrough, for example, there may be mentioned various types of resin materials, such as a cyclic polyolefin and a polycarbonate, and various types of metal materials, such as aluminum and stainless steel.

In addition, when being transparent or semi-transparent, the container 31 has an internal visibility; however, the container 31 may also be opaque.

When the volume of the receiving space 313 of the container 31 is represented by V1, and the total volume of the absorbing portion 34 before the waste liquid Q′ of the ink Q is absorbed is represented by V2, the ratio of V2 to V1, that is, the ratio V2/V1, is preferably 0.1 to 0.7 and more preferably 0.2 to 0.7. Accordingly, in the container 31, an air gap 315 is generated. Although the absorbing portion 34 may be expanded in some cases after the waste liquid Q′ of the ink Q is absorbed, the air gap 315 functions as a buffer when the absorbing portion 34 is expanded. Hence, the absorbing portion 34 can be sufficiently expanded, and the waste liquid Q′ can be sufficiently absorbed.

In addition, the liquid absorption system 100 shown in FIG. 1 included a lid 32 which covers the container 31.

The lid 32 has a plate shape and is able to liquid-tightly seal an upper opening 314 of the container 31. Accordingly, for example, even in the case in which after colliding on the absorbing portion 34, the waste liquid Q′ leaps up, the waste liquid Q′ can be prevented from scattering outside. In addition, the lid 32 may be formed integrally with the container 31, may have an air permeability at a sealing portion with the container 31, or may be omitted.

In the side wall portion 312 of the container 31, an insertion hole 316 is formed. The insertion hole 316 is a through-hole penetrating the side wall portion 312 in a thickness direction. In addition, in this insertion hole 316, the pipe 36 is inserted.

### 1.2.3 Discharge Portion

The discharge portion 33 discharges the waste liquid Q′ transported through the pipe 36 to the absorbing portion 34. The discharge portion 33 shown in FIG. 1 is provided most downstream of the pipe 36 with the organic solvent adsorbing portion 35 to be described later interposed therebetween. In addition, the discharge portion 33 shown in FIG. 1 is provided on a bottom surface of the organic solvent adsorbing portion 35 so as to face the lower side (Z-axis minus side). The waste liquid Q′ discharged from the discharge portion 33 drips right thereunder. In addition, the direction of the discharge portion 33 is not limited to that described above and may be different from the lower side.

### 1.2.4 Absorbing Portion

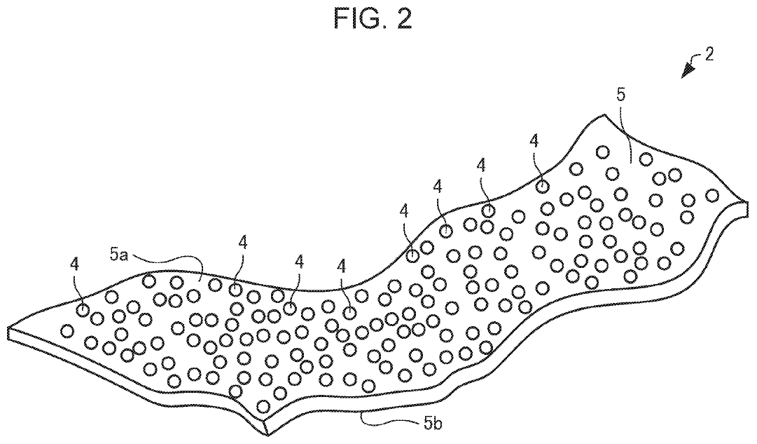

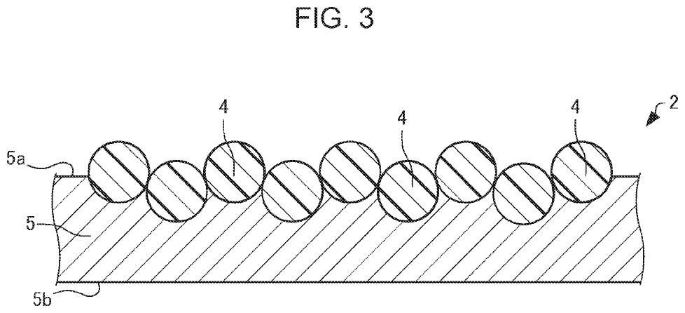

FIGS. 2 and 3 are each a view illustrating a small piece 2 which forms the absorbing portion 34 shown in FIG. 1.

The absorbing portion 34 shown in FIG. 1 is formed of an aggregate of the small pieces 2 shown in FIGS. 2 and 3. The small piece 2 includes, as shown in FIGS. 2 and 3, a base material 5 containing fibers and a water absorbing resin 4 which is a polymer absorbent supported by the base material 5. Since absorbing the waste liquid Q′ of the ink Q, the absorbing portion 34 suppresses leakage of the waste liquid Q′ from the liquid absorption system 100.

The small pieces 2 are obtained, for example, by cutting sheet-shaped waste paper which supports the water absorbing resin 4 into fine chip shapes with a shredder or the like. The small pieces 2 are each preferably a belt-shaped flexible piece. Accordingly, the small pieces 2 are easily deformed. Hence, when being received in the container 31, the small pieces 2 are deformed in accordance with the shape of the receiving space 313 of the container 31 and are easily received therein.

The entire length of the small piece 2, that is, the length of the long side thereof, is preferably 0.5 to 200 mm, more preferably 1 to 100 mm, and further preferably 2 to 30 mm.

The width of the small piece 2, that is, the length of the short side thereof, is preferably 0.1 to 100 mm, more preferably 0.3 to 50 mm, and further preferably 1 to 20 mm.

A ratio (aspect ratio) of the entire length to the width of the small piece 2 is preferably 1 to 200 and more preferably 1 to 30. The thickness of the small piece 2 is preferably 0.05 to 2 mm and more preferably 0.1 to 1 mm.

When the dimensions are each in the range described above, the support of the water absorbing resin 4, the retention of the waste liquid Q′ by the base material 5, and the transportation of the waste liquid Q′ to the water absorbing resin 4 can be more preferably performed. In addition, the absorbing portion 34 formed of the aggregate of the small pieces 2 is more likely to be deformed, and the shape followability to the container 31 can be improved.

In addition, in the absorbing portion 34, small pieces 2 having the same value of at least one of the entire length, the width, the aspect ratio, and the thickness may be contained, or small pieces 2 having different values of all of those mentioned above may also be contained.

In the absorbing portion 34, the content of small pieces 2 having a maximum width of 3 mm or less is preferably 30 to 90 percent by mass and more preferably 40 to 80 percent by mass. Accordingly, absorbing characteristics of the waste liquid Q′ in the absorbing portion 34 can be suppressed from fluctuating.

In addition, if the content of the small pieces 2 having a maximum width of 3 mm or less is lower than the above lower limit, when the absorbing portion 34 is received in the container 31, large voids are liable to be formed between the small pieces 2, and the absorbing characteristics of the waste liquid Q′ in the absorbing portion 34 may fluctuate in some cases. On the other hand, if the content of the small pieces 2 having a maximum width of 3 mm or less is above the upper limit described above, voids are not likely to be formed between the small pieces 2, and hence, a bulk density of the absorbing portion 34 may be difficult to adjust in some cases.

The small pieces 2 may have irregular shapes but preferably have common regular shapes. Accordingly, the bulk density of the absorbing portion 34 is not likely to fluctuate, and the absorbing characteristics of the waste liquid Q′ can be suppressed from fluctuating. In the absorbing portion 34, the content of small pieces 2 having regular shapes in the total of the absorbing portion 34 is preferably 30 percent by mass or more, more preferably 50 percent by mass or more, and further preferably 70 percent by mass or more.

In the receiving space 313 of the container 31, the small pieces 2 are preferably randomly received so as not to have regularity in terms of the directions of the long sides. Accordingly, the voids are likely to be formed between the small pieces 2. As a result, the permeability of the waste liquid Q′ in the absorbing portion 34 can be more increased.

The bulk density of the absorbing portion 34 is preferably 0.01 to 0.5 g/cm³, more preferably 0.03 to 0.3 g/cm³, and further preferably 0.05 to 0.2 g/cm³. Accordingly, besides the permeability of the waste liquid Q′, the retention property thereof in association with a capillary phenomenon can be secured.

### 1.2.4.1 Fibers

As the fibers contained in the base material 5, for example, there may be mentioned synthetic resin fibers, such as polyester fibers or polyamide fibers, natural fibers, such as cellulose fibers (pulp fibers), keratin fibers, or fibroin fibers, or a chemical modified product thereof, and those fibers mentioned above may be used alone, or at least two types thereof may be used in combination.

Among those fibers mentioned above, as the polyester fibers, for example, there may be mentioned poly(ethylene terephthalate) (PET) fibers, poly(ethylene naphthalate) (PEN) fibers, poly(trimethylene terephthalate) (PTT) fibers, or poly(tributylene terephthalate) (PBT) fibers.

In addition, as the polyamide fibers, for example, aliphatic polyamide fibers, such as nylon fibers, or aromatic polyamide fibers, such as aramid fibers, may be mentioned.

The cellulose fibers indicate fibers containing a cellulose as a chemical compound, that is, a cellulose in a narrow sense, as a primary component. In addition, the cellulose fibers may also contain, besides a cellulose, a hemicellulose and/or a lignin.

The fibers contained in the base material 5 are preferably cellulose fibers. Since the cellulose fibers are a material having a hydrophilic property, when being applied to the cellulose fibers, the waste liquid Q′ of the ink Q can be preferably permeated therethrough, and the waste liquid Q′ thus permeated can be efficiently transported to the water absorbing resin 4. In addition, since a cellulose generally has a high affinity to the water absorbing resin 4, the water absorbing resin 4 can be more preferably supported on the surface of the base material 5. In addition, the cellulose fibers are a regenerable natural raw material and, among various fibers, are easily available at an inexpensive price. For example, cellulose fibers derived from old paper are produced at a relatively low cost and also contribute to reduction of environmental load. Hence, in view of reduction of the production cost of the small pieces 2, stable production thereof, reduction of environmental load, and the like, the cellulose fibers are also advantageous.

As described above, the absorbing portion 34 according to this embodiment is preferably formed of the aggregate of the small pieces 2 each including the base material 5 containing cellulose fibers and the water absorbing resin 4, which is a polymer absorbent, supported by this base material 5.

According to the structure as described above, when the absorbing portion 34 is received in the container 31, an effect in that the absorbing portion 34 is deformed in accordance with the shape of the receiving space 313 and is smoothly received therein and an effect in that the waste liquid Q′ is efficiently permeated in the base material 5 and is efficiently absorbed in the water absorbing resin 4 can be obtained at the same time. In addition, since the absorbing portion 34 as described above uses a cellulose, that is, a nature-derived material, a support property of the water absorbing resin 4 by the base material 5 is excellent, and an effect to contribute to the reduction of environmental load can also be obtained.

Although not particularly limited, the average length of the fibers contained in the base material 5 is preferably 0.1 to 7.0 mm, more preferably 0.1 to 5.0 mm, and further preferably 0.2 to 3.0 mm.

Although not particularly limited, the average diameter of the fibers is preferably 0.05 to 2.00 mm and more preferably 0.10 to 1.00 mm.

Although not particularly limited, the average aspect ratio, that is, the ratio of the average length to the average diameter, of the fibers is preferably 10 to 1,000 and more preferably 15 to 500.

In addition, the average length and the average diameter of the fibers are average values of the lengths and the diameters, respectively, of at least 100 fibers.

When the average values are in the ranges described above, the support of the water absorbing resin 4, the retention of the waste liquid Q′ by the base material 5, and the transportation of the waste liquid Q′ to the water absorbing resin 4 can be more preferably performed.

In addition, the fibers contained in the small pieces 2 are not limited to those forming the base material 5, and fibers entangled with each other may also be used.

### 1.2.4.2 Water Absorbing Resin

As shown in FIGS. 2 and 3, the water absorbing resin 4 contained in the small piece 2 is supported by the base material 5. In the example shown in the drawings, the water absorbing resin 4 is supported only by one side surface 5a of the base material 5. In addition, although not shown in the drawings, the water absorbing resin 4 may be supported only by the other side surface 5b of the base material 5 or by the two side surfaces thereof. As described above, the small piece 2 is formed of the base material 5 which supports the water absorbing resin 4.

In addition, as shown in FIG. 3, the water absorbing resin 4 may partially or entirely intrude in the base material 5 from the one side surface 5a thereof. That is, the water absorbing resin 4 may be partially impregnated in the base material 5. Accordingly, a support force of the base material 5 for the water absorbing resin 4 can be increased, and the water absorbing resin 4 is suppressed from falling from the base material 5. As a result, the absorbing portion 34 formed as the aggregate of the small pieces 2 is able to have excellent absorbing characteristics of the waste liquid Q′ for a long time. Furthermore, the water absorbing resin 4 is suppressed from being unevenly distributed in the receiving space 313.

Furthermore, the small piece 2 may include a plurality of base materials 5 and the water absorbing resin 4 provided between the base materials 5. Since the water absorbing resin 4 is provided between the base materials 5, the water absorbing resin 4 is suppressed from falling from the small piece 2.

The water absorbing resin 4 is a super absorbent polymer (SAP) having a water absorbing property. The water absorption indicates a function to have a hydrophilic property and to retain a liquid, such as the ink Q or the waste liquid Q′ thereof. The water absorbing resin 4 may be gelled after water absorption.

In particular, as the water absorbing resin 4 according to this embodiment, an anionic water absorbing resin is preferably contained. The anionic water absorbing resin is a resin in which when moisture in a liquid is absorbed, its hydrophilic group is dissociated, and an anionic group is generated. In the anionic water absorbing resin as described above, although long polymer chains are densely entangled with each other under dry conditions, when absorbing moisture in a liquid once, the hydrophilic group tends to be dissolved in water, and the polymer chains start to be disentangled. Accordingly, a large amount of the liquid can be absorbed.

On the other hand, depending on the case in which a solute contained in the liquid is an electrolyte or a non-electrolyte, the anionic water absorbing resin shows different absorbing characteristics. For example, when the solute contained in the liquid is a non-electrolyte, regardless of the concentration of the non-electrolyte, an absorption amount of the liquid shows a relatively high value. Hence, for a pigment ink which is a liquid containing a non-electrolyte, regardless of the concentration of the non-electrolyte, the anionic water absorbing resin shows relatively good absorbing characteristics.

On the other hand, for a liquid containing an electrolyte, as the concentration of the electrolyte is increased, the absorption amount of the liquid by the anionic water absorbing resin tends to decrease. Hence, for a dye ink which is a liquid containing an electrolyte, the anionic water absorbing resin tends to show insufficient absorbing characteristics.

Although the anionic water absorbing resin is not particularly limited as long as being a rein having an anionic group upon absorption of water, for example, there may be mentioned a carboxymethyl cellulose, a poly(acrylic acid), a polyacrylamide, a starch-acrylic acid graft copolymer, a hydrolysate of a starch-acrylonitrile graft copolymer, a vinyl acetate-acrylic acid ester copolymer, a copolymer of isobutylene and maleic acid, a hydrolysate of an acrylonitrile copolymer or an acrylamide copolymer, a polyethylene oxide, a polysulfonic acid-based compound, a polyglutamic acid, or a salt, a modified compound, or a cross-linked compound of those mentioned above.

The anionic water absorbing resin is preferably a resin having a functional group on its side chain. As the functional group, for example, there may be mentioned an acid group, a carboxy group, a hydroxy group, an epoxy group, or an amino group. In particular, a resin having an acid group on its side chain is preferable, and a resin having a carboxy group on its side chain is more preferable.

As a carboxy group-containing unit forming a side chain, for example, there may be mentioned a unit derived from acrylic acid, methacrylic acid, itaconic acid, maleic acid, crotonic acid, fumaric acid, sorbic acid, cinnamic acid, or a monomer, such as an anhydride or a salt, of each of those mentioned above.

In the anionic water absorbing resin having an acid group on its side chain, among the acid groups contained in the anionic water absorbing resin, the rate of an acid group which forms a salt by neutralization is preferably 30 to 100 percent by mole, more preferably 50 to 95 percent by mole, further preferably 60 to 90 percent by mole, and even further preferably 70 to 80 percent by mole. Accordingly, the anionic water absorbing resin is made to have excellent water absorbing characteristics of the waste liquid Q′.

As the type of neutralized salt, for example, there may be mentioned an alkali metal salt, such as a sodium salt, a potassium salt, or a lithium salt, or a salt of a nitrogen-containing basic compound, such as ammonium, and among those mentioned above, a sodium salt is preferable. Accordingly, the anionic water absorbing resin is able to have excellent absorbing characteristics of the waste liquid Q′.

The anionic water absorbing resin having an acid group on its side chain is preferable since when the waste liquid Q′ is absorbed, electrostatic repulsion occurs between the acid groups, and an absorbing rate is increased. In addition, when the acid group is neutralized, by the osmotic pressure, the waste liquid is likely to be absorbed in the anionic water absorbing resin.

The anionic water absorbing resin may have a constituent unit containing no acid group on its side chain. As the constituent unit described above, for example, there may be mentioned a hydrophilic constituent unit, a hydrophobic constituent unit, or a constituent unit used as a polymerizable cross-linking agent.

As the hydrophilic constituent unit described above, for example, there may be mentioned a constituent unit derived from a nonionic compound, such as acrylamide, methacrylamide, N-ethyl (meth) acrylamide, N-n-propyl (meth) acrylamide, N-isopropyl (meth) acrylamide, N,N-dimethyl (meth)acrylamide, 2-hydroxyethyl (meth) acrylate, 2-hydroxypropyl (meth)acrylate, a methoxypolyethylene glycol (meth)acrylate, a polyethylene glycol mono(meth)acrylate, N-vinylpyrrolidone, N-acryloylpiperidine, or N-acryloylpyrrolidine.

As the hydrophobic constituent unit described above, for example, there may be mentioned a constituent unit derived from a compound, such as (meth)acrylonitrile, styrene, vinyl chloride, butadiene, isobutene, ethylene, propylene, stearyl (meth)acrylate, or lauryl (meth)acrylate.

As the constituent unit used as a polymerizable cross-linking agent, for example, there may be mentioned a constituent unit derived from diethylene glycol diacrylate, N,N-methylene bisacrylamide, a polyethylene glycol diacrylate, a polypropylene glycol diacrylate, trimethylolpropane diallyl ether, trimethylolpropane triacrylate, allyl glycidyl ether, pentaerythritol triallyl ether, pentaerythritol diacrylate monostearate, bisphenol diacrylate, isocyanuric acid diacrylate, tetraallyl oxyethane, or diallyl oxyacetic acid salt.

The water absorbing resin 4 preferably includes a polyacrylic acid salt copolymer or a polyacrylic acid cross-linked polymer. Accordingly, for example, the absorption performance for the waste liquid Q′ may be improved, and/or the production cost may be reduced.

As the polyacrylic acid cross-linked polymer, the rate of a constituent unit having a carboxy group occupied in the total constituent units forming the molecular chain is preferably 50 percent by mole or more, more preferably 80 percent by mole or more, and further preferably 90 percent by mole or more. When the rate of the constituent unit containing a carboxy group is excessively low, it may be difficult to obtain sufficiently excellent absorbing characteristics of the waste liquid Q′ in some cases.

The carboxy group in the polyacrylic acid cross-linked polymer is preferably partially neutralized to form a salt. The rate of neutralized groups occupied in all the carboxy groups of the polyacrylic acid cross-linked polymer is preferably 30 to 99 percent by mole, more preferably 50 to 99 percent by mole, and further preferably 70 to 99 percent by mole.

In addition, the water absorbing resin 4 may have the structure cross-linked by a cross-linking agent other than the polymerizable cross-linking agent described above.

When the water absorbing resin 4 is a resin having an acid group, as the cross-linking agent, for example, a compound having a plurality of functional groups which react with the acid group is preferably used. When the water absorbing resin 4 is a resin having at least one functional group which reacts with the acid group, as the cross-linking agent, a compound having a plurality of functional groups which react with the acid group in its molecule is preferably used.

As the cross-linking agent having a plurality of functional groups which react with the acid group, for example, there may be mentioned a glycidyl ether compound, such as ethylene glycol glycidyl ether, trimethylolpropane triglycidyl ether, a (poly)glycerin polyglycidyl ether, a diglycerin polyglycidyl ether, or propylene glycol diglycidyl ether; a polyvalent alcohol, such as a (poly)glycerin, a (poly)ethylene glycol, propylene glycol, 1,3-propanediol, a polyoxyethylene glycol, triethylene glycol, tetraethylene glycol, diethanolamine, or triethanolamine; or a polyamine, such as ethylenediamine, diethylenediamine, a polyethyleneimine, or hexamethylenediamine. In addition, since polyvalent ions of zinc, calcium, magnesium, aluminum, or the like react with the acid group of the water absorbing resin 4 and function as a cross-linking agent, those ions mentioned above may be preferably used.

Although the water absorbing resin 4 may have any shapes, such as flakes, needles, fibers, or particles, most of the resin preferably has particle shapes. When the water absorbing resin 4 has particle shapes, the permeability of the waste liquid Q′ can be easily secured. In addition, the water absorbing resin 4 can be preferably supported by the base material 5. In addition, the particle shape indicates that the aspect ratio, that is, the ratio of the minimum length to the maximum length, is 0.3 to 1.0. The average particle diameter of the particles is preferably 50 to 800 μm, more preferably 100 to 600 μm, and further preferably 200 to 500 μm.

In addition, as the average particle diameter of the particles, for example, a volume average particle size MVD (mean volume diameter) measured, for example, by a laser diffraction particle size measurement device may be used. This particle size MVD may be obtained from a particle size distribution measured on a volume basis by a particle size distribution measurement device, that is, a laser diffraction particle size measurement device, using a laser diffraction/scattering method as a measurement principle.

When the average particle diameter of the water absorbing resin 4 and the average length of the fibers are represented by D [μm] and L [μm], respectively, 0.15≤L/D≤467 is preferably satisfied, 0.25≤L/D≤333 is more preferably satisfied, and 2≤L/D≤200 is further preferably satisfied.

A mass ratio of the water absorbing resin 4 with respect to the base material 5 is preferably 0.15 to 1.75, more preferably 0.20 to 1.50, and further preferably 0.25 to 1.20. Accordingly, the permeability of the waste liquid Q′ in the absorbing portion 34 and the absorbing characteristics of the waste liquid Q′ by the water absorbing resin 4 can be satisfied at the same time.

In addition, when the mass ratio of the water absorbing resin 4 is lower than the lower limit described above, the absorption amount by the water absorbing resin 4 may be unfavorably insufficient in some cases. On the other hand, when the mass ratio of the water absorbing resin 4 is over the upper limit described above, the water absorbing resin 4 is relatively excessive, and by a swelled water absorbing resin 4, the permeability of the waste liquid Q′ in the base material 5 may be disturbed in some cases.

The absorbing portion 34 may also contain various additives other than the base material 5 and the water absorbing resin 4. As the additives, for example, there may be mentioned a surfactant, a lubricant, a defoaming agent, a filler, a blocking inhibitor, an ultraviolet absorbent, a colorant, such as a pigment or a dye, a flame retardant, and/or a flow improver.

Among those additives mentioned above, as the flame retardant, for example, there may be mentioned a halogen-based flame retardant, a phosphorous-based flame retardant, a nitrogen compound-based flame retardant, a silicone-based flame retardant, or an inorganic-based flame retardant.

### 1.2.5 Organic Solvent Adsorbing Portion

The organic solvent adsorbing portion 35 is provided between the pipe 36 and the discharge portion 33. The organic solvent adsorbing portion 35 adsorbs an organic solvent contained in the waste liquid Q′. Since the organic solvent adsorbing portion 35 as described above is provided, the organic solvent in the waste liquid Q′ transported from the pipe 36 to the discharge portion 33 can be decreased. A relatively large amount of the organic solvent is contained in a dye ink than that in a pigment ink. When a large amount of the organic solvent as described above is supplied to the absorbing portion 34, the absorption amount of the waste liquid Q′ in the absorbing portion 34 is disadvantageously decreased in some cases.

Hence, in this embodiment, the liquid absorption system 100 is configured such that before the waste liquid Q′ comes in contact with the absorbing portion 34, the waste liquid Q′ passes through the organic solvent adsorbing portion 35. In particular, the organic solvent adsorbing portion 35 according to this embodiment is provided between the pipe 36 and the discharge portion 33. Since the organic solvent adsorbing portion 35 is provided at the position as described above, before the waste liquid Q′ comes in contact with the absorbing portion 34, the organic solvent in the waste liquid Q′ can be decreased in advance. Hence, even when the waste liquid Q′ passing through the organic solvent adsorbing portion 35 is supplied to the absorbing portion 34, the absorption amount, in particular, the absorption amount of moisture, in the absorbing portion 34 can be suppressed from being decreased due to the organic solvent. In addition, since the organic solvent adsorbing portion 35 is provided in the receiving space 313 of the container 31, for example, the organic solvent adsorbing portion 35 can be handled together with the container 31. Hence, for example, an organic solvent adsorbing portion 35 which is excessively used over the use limit can be easily removed from the image forming apparatus 200.

In addition, although not shown in the drawings, the organic solvent adsorbing portion 35 may also function as the discharge portion 33. That is, the organic solvent adsorbing portion 35 is provided at the discharge portion 33 and may have the function thereof. In this case, as is the case described above, the absorption amount in the absorbing portion 34 can also be suppressed from being decreased.

As the organic solvent adsorbing portion 35, any member including an adsorbent capable of adsorbing an organic solvent may be used. As the adsorbent, for example, there may be mentioned active carbon, zeolite, silica gel, alumina gel, silica alumina gel, activated white earth, molecular sieve, molecular sieving carbon, an aromatic-based synthetic adsorbent, or a methacrylic acid ester-based synthetic adsorbent, and those adsorbents mentioned above may be used alone, or at least two types thereof may be used in combination.

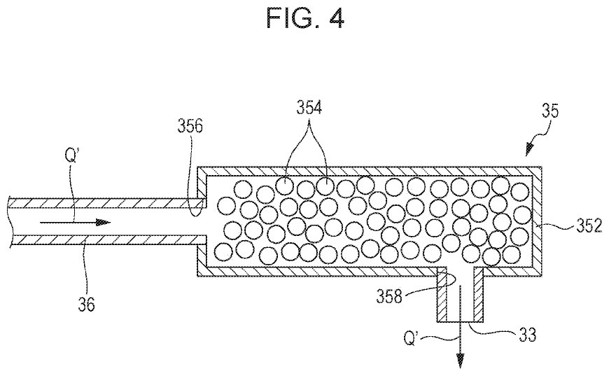

FIG. 4 is an enlarged cross-sectional view of the organic solvent adsorbing portion 35 shown in FIG. 1.

The organic solvent adsorbing portion 35 shown in FIG. 4 includes an adsorbing portion container 352 and an adsorbent 354 received in the adsorbing portion container 352.

The adsorbing portion container 352 has a pipe hole portion 356 in which the pipe 36 is to be inserted and a discharge hole portion 358 to which the discharge portion 33 is to be fitted. The adsorbing portion container 352 has a liquid-tight property and temporarily stores the waste liquid Q′ transported through the pipe 36. In this step, the adsorbent 354 received in the adsorbing portion container 352 is in contact with the waste liquid Q′. The discharge hole portion 358 is located at a position opposite to the pipe hole portion 356 in the adsorbing portion container 352. Hence, the waste liquid Q′ in contact with the adsorbent 354 drips from the discharge hole portion 358 in the receiving space 313 of the container 31 through the discharge portion 33. As described above, the contact opportunity between the waste liquid Q′ and the adsorbent 354 can be secured, and the organic solvent in the waste liquid Q′ can be adsorbed to the adsorbent 354.

Although the form of the adsorbent 354 is not particularly limited, besides the particles shown in FIG. 4, for example, fibers, clumps, or cloths may be mentioned.

In addition, the structure of the organic solvent adsorbing portion 35 is not limited to that described above. For example, the adsorbing portion container 352 and the adsorbent 354 may be integrally formed.

In addition, when the water absorbing resin 4 functioning as a polymer absorbent contains an anionic water absorbing resin, the organic solvent adsorbing portion 35 preferably contains active carbon. When the active carbon is used, of organic solvents, in particular, an organic solvent having a composition which is liable to disturb the absorption of the waste liquid Q′ in the anionic water absorbing resin is likely to be adsorbed to the active carbon. Hence, even when a dye ink containing a relatively large amount of an organic solvent is recovered as a waste liquid, the organic solvent thereof can be removed by the organic solvent adsorbing portion 35. As a result, in the absorbing portion 34, disturbance of the absorption caused by the organic solvent is not likely to occur, and a sufficient amount of the waste liquid Q′ can be absorbed in the absorbing portion 34.

In addition, among the organic solvents, an organic solvent having an SP value of 10 or less is liable to disturb the absorbing characteristics of the water absorbing resin 4. In consideration of the fact described above, the organic solvent adsorbing portion 35 preferably adsorbs an organic solvent having an SP value of 10 or less. Since the organic solvent adsorbing portion 35 as described above is used, the absorbing characteristics of the water absorbing resin 4 can be particularly suppressed from being degraded.

The SP value of the organic solvent is called a “solubility parameter” and is a physical value defined by the square root of a cohesive energy density which is obtained by dividing the cohesive energy by the volume. As a method for calculating the cohesive energy of an organic solvent, for example, methods using various calculating formulas, such as Small formula, Fedors formula, and Hoftyzer-Van krevelen formula, may be mentioned.

Furthermore, as the organic solvent adsorbing portion 35, although any member capable of adsorbing an organic solvent having an SP value of 10 or less may be used, a member having the following performance is preferable.

When the waste liquid Q′ which is a liquid before coming in contact with the organic solvent adsorbing portion 35 contains an organic solvent having an SP value of 10 or less at a first content of 2 percent by mass or more, a liquid after coming in contact with the organic solvent adsorbing portion 35 is a waste liquid Q′ in which the content of the organic solvent having an SP value of 10 or less is preferably less than the first content and 3 percent by mass or less and more preferably less than the first content and 2 percent by mass or less.

Since the organic solvent adsorbing portion 35 has the adsorbing performance as described above, the absorption amount of the waste liquid Q′ in the absorbing portion 34 can be sufficiently secured. When an organic solvent having an SP value of 10 or less acts on the absorbing portion 34, the absorption of the waste liquid Q′ in the absorbing portion 34 is disturbed; however, according to this embodiment, the disturbance described above can be sufficiently suppressed. Hence, a designed absorption amount can be realized in the absorbing portion 34.

As described above, the liquid absorption system 100 according to this embodiment includes the pipe 36 through which the waste liquid Q′ which is a liquid containing an organic solvent is transported; the discharge portion 33 which discharges the waste liquid Q′ transported through the pipe 36; the container 31 which recovers the waste liquid Q′ discharged from the discharge portion 33; the absorbing portion 34 which is received in the container 31 and which includes the water absorbing resin 4, which is a polymer absorbent, absorbing the waste liquid Q′; and the organic solvent adsorbing portion 35 which adsorbs the organic solvent contained in the waste liquid Q′. In addition, the organic solvent adsorbing portion 35 is provided at a position at which the organic solvent adsorbing portion 35 comes in contact with the waste liquid Q′ before the waste liquid Q′ comes in contact with the absorbing portion 34.

According to the structure as described above, since the organic solvent in the waste liquid Q′ is adsorbed in advance by the organic solvent adsorbing portion 35, the absorbing portion 34 is prevented from being brought into contact with a large amount of the organic solvent. Hence, the absorption amount of the waste liquid Q′ in the absorbing portion 34 is prevented from being decreased due to the organic solvent, and regardless of the composition of the waste liquid Q′, a sufficient absorption amount can be secured. As a result, a liquid absorption system 100 excellent in absorption ability for the waste liquid Q′ by the polymer absorbent can be realized. In particular, in the case of a liquid, such as a dye ink, containing water as a primary component and a relatively large amount of an organic solvent, the effect as described above is significant.

### 1.3 Method for Manufacturing Liquid Absorption System

Next, a method for manufacturing the liquid absorption system 100 will be described.

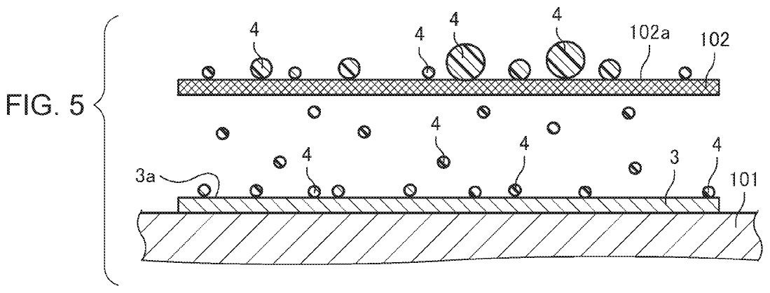

FIGS. 5 to 7 are views each illustrating a method for manufacturing the absorbing portion 34 of the liquid absorption system 100 shown in FIG. 1.

First, as shown in FIG. 5, a sheet-shaped sheet member 3, such as old paper, is disposed on a stage 101. On the sheet member 3 thus disposed, water or an aqueous resin is applied and spread.

Next, the water absorbing resin 4 is applied to one side surface 3a of the sheet member 3 with a mesh member 102 interposed therebetween. The mesh member 102 has meshes 102a. Of the water absorbing resin 4, particles each having a larger size than the mesh 102a are trapped by the mesh member 102, and particles each having a smaller size than the mesh 102a are applied on the surface 3a of the sheet member 3 through the meshes 102a. Hence, by a tack force obtained by water absorption or an adhesive force by a water soluble resin, the water absorbing resin 4 is fixed and supported on the surface 3a of the sheet member 3.

As described above, since the mesh member 102 is used, the uniformity of particle diameters of the water absorbing resin 4 can be increased. Hence, the absorbing characteristics are suppressed from fluctuating depending on the position of the sheet member 3.

The maximum width of the mesh 102a is preferably 0.06 to 0.15 mm and more preferably 0.08 to 0.12 mm. Accordingly, the particle diameters of the water absorbing resin 4 to be applied to the sheet member 3 can be set in the numerical range described above.

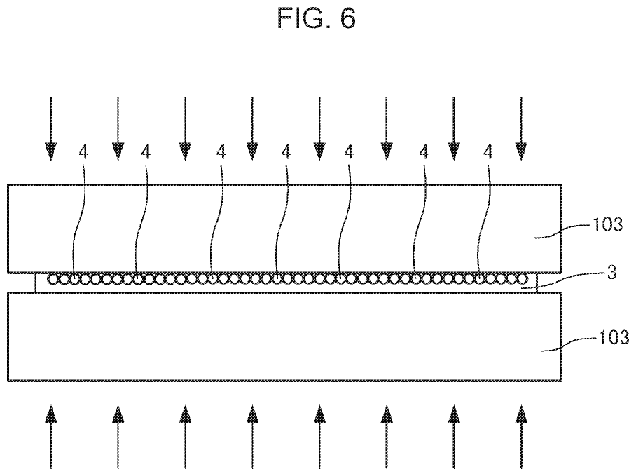

Next, as shown in FIG. 6, the sheet member 3 to which the water absorbing resin 4 is adhered is disposed between a pair of heating blocks 103. Subsequently, the pair of heating blocks 103 is heated, and at the same time, the pressure is applied in a direction such that the two heating blocks 103 come close to each other; hence, the sheet member 3 is pressurized in a thickness direction. Accordingly, the water absorbing resin 4 is softened and is then allowed to intrude in the sheet member 3 by the pressure application.

A pressure to be applied in this step is preferably 0.1 to 1.0 kg/cm² and more preferably 0.2 to 0.8 kg/cm². A heating temperature in this step is preferably 80° C. to 160° C. and more preferably 100° C. to 120° C.

Next, the sheet member 3 is formed into small parts by finely cutting/crushing/pulverizing using scissors, a cutter, a mill, a shredder, or the like or by tearing with hands. Accordingly, a plurality of small pieces 2 is obtained, and the absorbing portion 34 formed from an aggregate of the small pieces 2 is obtained.

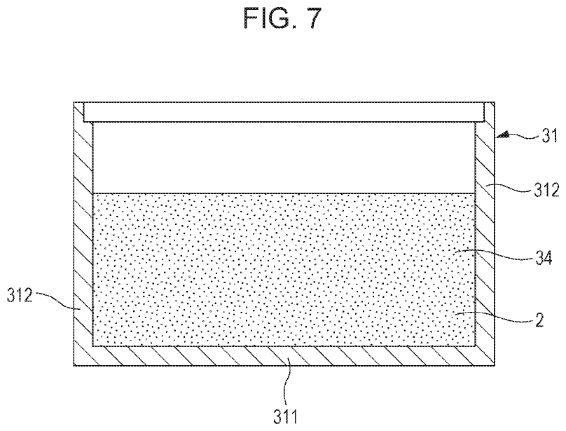

In addition, after a desired amount of the small pieces 2 thus obtained is measured, the small pieces 2 are disentangled, for example, with hands to adjust the bulk density and are then received in the container 31. Accordingly, as shown in FIG. 7, the absorbing portion 34 is received in the container 31.

### 2. First Modified Example

Next, a liquid absorption system according to a first modified example will be described.

In the liquid absorption system 100 according to the first embodiment described above, the absorbing portion 34 is formed of the aggregate of the small pieces 2. On the other hand, in a liquid absorption system 100 according to the first modified example, the absorbing portion 34 is formed of a resin base material (not shown) and the water absorbing resin 4 supported by the resin base material.

As a constituent material of the resin base material, for example, there may be mentioned a resin material, such as an urethane foam, a foamed polystyrene, a foamed polyethylene, a foamed polypropylene, or a vinyl lactam-based cross-linked polymer.

The form of the resin base material is not particularly limited and may be clumps, small pieces, particles, or shapes others than those mentioned above.

A mass ratio of the water absorbing resin 4 to the resin base material is preferably 0.15 to 1.75, more preferably 0.20 to 1.50, and further preferably 0.25 to 1.20. Accordingly, the permeability of the waste liquid Q′ in the absorbing portion 34 and the absorbing characteristics of the waste liquid Q′ by the water absorbing resin 4 can be obtained at the same time.

In addition, when the mass ratio of the water absorbing resin 4 is lower than the lower limit described above, the absorption amount by the water absorbing resin 4 may be insufficient in some cases. On the other hand, when the mass ratio of the water absorbing resin 4 is over the upper limit described above, the water absorbing resin 4 is relatively excessive, and the permeation of the waste liquid Q′ in the resin base material may be disturbed by a swelled water absorbing resin 4 in some cases.

In the first modified example as described above, an effect similar to that in the first embodiment may also be obtained.

### 3. Second Modified Example

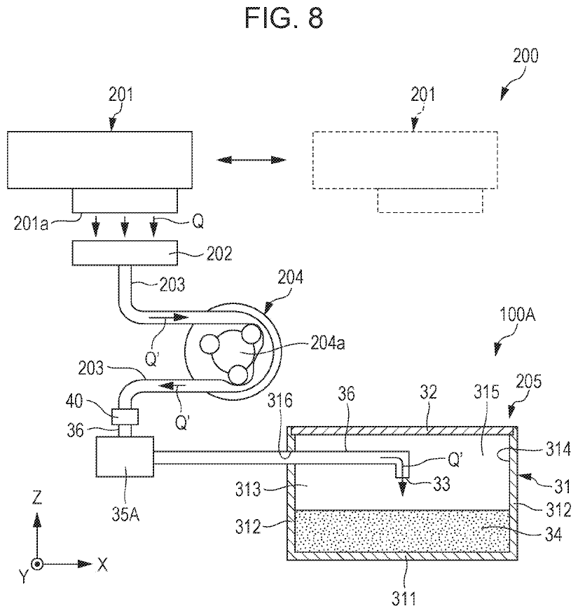

FIG. 8 is a partially vertical cross-sectional view of a liquid absorption system 100A according to a second modified example.

Hereinafter, although the second modified example will be described, in the following description, points different from the first embodiment will be mainly described, and description of matters similar to those of the first embodiment will be omitted. In addition, in FIG. 8, a constituent element similar to that of the first embodiment will be designated by the same reference numeral.

The liquid absorption system 100A according to the second modified example is similar to the liquid absorption system 100 according to the first embodiment except for the position of an organic solvent adsorbing portion 35A.

In the liquid absorption system 100A shown in FIG. 8, the organic solvent adsorbing portion 35A is provided on the way of the pipe 36.

According to the structure as described above, before coming in contact with the absorbing portion 34, the waste liquid Q′ passes through the organic solvent adsorbing portion 35A. Hence, even when the waste liquid Q′ is supplied to the absorbing portion 34, the absorption amount in the absorbing portion 34 is suppressed from being decreased. In addition, since the organic solvent adsorbing portion 35A is provided outside of the container 31, without receiving any restriction of the volume of the container 31, the organic solvent adsorbing portion 35A can be easily formed to have a larger size. Accordingly, the adsorption amount of the organic solvent in the organic solvent adsorbing portion 35a can be increased, and the organic solvent adsorbing portion 35A can be used for a long time without performing an exchange operation thereof. Furthermore, since the container 31 is not required to receive the organic solvent adsorbing portion 35A, corresponding to the volume thereof, the size of the container 31 can also be reduced.

In addition, the organic solvent adsorbing portion 35A shown in FIG. 8 may be configured to be detachable to the pipe 36. Accordingly, the exchange operation of the organic solvent adsorbing portion 35A can be easily performed. In addition, although being provided on the way of the pipe 36, the organic solvent adsorbing portion 35A shown in FIG. 8 may be provided at an upstream end portion or a downstream end portion of the pipe 36.

In the second modified example described above, an effect similar to that of the first embodiment may also be obtained.

### 4. Third Modified Example

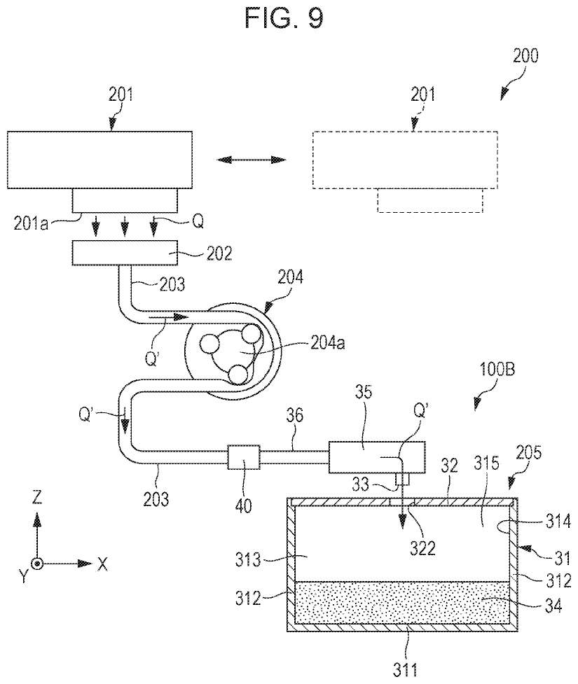

FIG. 9 is a partially vertical cross-sectional view showing a liquid absorption system 100B according to a third modified example.

Hereinafter, although the third modified example will be described, in the following description, points different from the first embodiment will be mainly described, and description of matters similar to those of the first embodiment will be omitted. In addition, in FIG. 9, a constituent element similar to that of the first embodiment will be designated by the same reference numeral.

The liquid absorption system 100B according to the third modified example is similar to the liquid absorption system 100 according to the first embodiment except for the positions of the organic solvent adsorbing portion 35, the discharge portion 33, and the like.

In the liquid absorption system 100 according to the first embodiment described above, the organic solvent adsorbing portion 35 is located in the receiving space 313 of the container 31. On the other hand, in the liquid absorption system 100B according to the third modified example, the organic solvent adsorbing portion 35 is provided outside of the container 31. In addition, besides the organic solvent adsorbing portion 35, the pipe 36 and the discharge portion 33 are also provided outside of the container 31.

In addition, a lid 32 shown in FIG. 9 has a waste liquid passing opening 322 penetrating along the Z axis. In addition, the positions of the discharge portion 33 and the waste liquid passing opening 322 are set so that a waste liquid Q′ which drips from the discharge portion 33 passes through the waste liquid passing opening 322.

According to the structure as described above, since the container 31 and the pipe 36 can be separated from each other, in particular, an operation of exchanging the container 31 receiving the absorbing portion 34 can be easily performed. In addition, as is the case of the above second modified example, since the organic solvent adsorbing portion 35 can be provided outside of the container 31, without receiving any restriction of the volume of the container 31, the organic solvent adsorbing portion 35 can be formed to have a larger size. Hence, the adsorption amount of the organic solvent in the organic solvent adsorbing portion 35 can be increased.

In the third modified example described above, an effect similar to that of the first embodiment may also be obtained.

### 5. Second Embodiment

Next, a liquid absorption unit according to a second embodiment will be described.

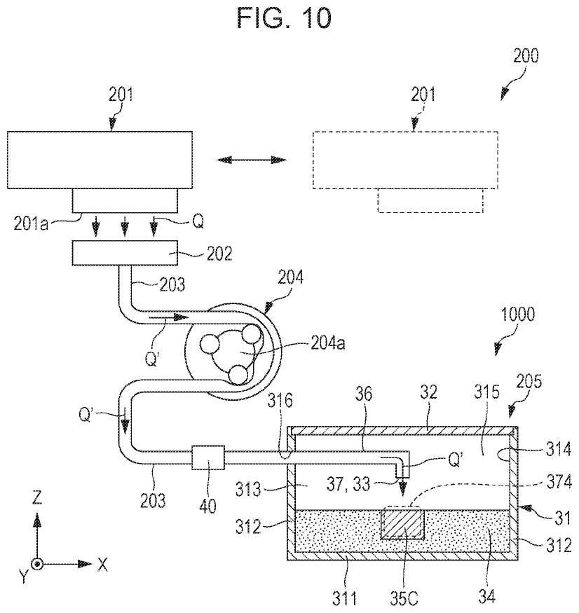

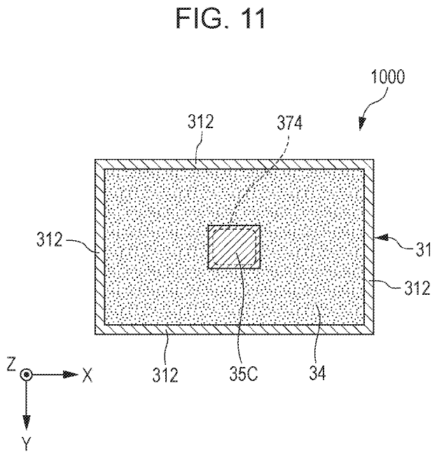

FIG. 10 is a partially vertical cross-sectional view showing the liquid absorption unit according to the second embodiment. FIG. 11 is a horizontal cross-sectional view of the liquid absorption unit shown in FIG. 10.

Hereinafter, although the second embodiment will be described, in the following description, points different from the first embodiment will be mainly described, and description of matters similar to those of the first embodiment will be omitted. In addition, in FIGS. 10 and 11, a constituent element similar to that of the first embodiment will be designated by the same reference numeral.

A liquid absorption unit 1000 according to the second embodiment is similar to the liquid absorption system 100 according to the first embodiment except for the following structure.

In the liquid absorption systems according to the first embodiment and its modified examples, the organic solvent adsorbing portion is provided at the pipe 36 or the discharge portion 33 or between the pipe 36 and the discharge portion 33. On the other hand, in the liquid absorption unit 1000 according to this embodiment, an organic solvent adsorbing portion 35C is separated from the pipe 36 and the discharge portion 33 and is disposed in the receiving space 313 of the container 31. In particular, the organic solvent adsorbing portion 35C shown in FIG. 10 is disposed in the receiving space 313 together with the absorbing portion 34.

In addition, as shown in FIG. 10, the organic solvent adsorbing portion 35C is provided right under an introduction portion 37. In addition, the structure of the introduction portion 37 is similar to that of the discharge portion 33 according to the first embodiment. In the horizontal cross-sectional view of FIG. 11, the absorbing portion 34 is provided to have an annular shape so as to surround the organic solvent adsorbing portion 35C. Furthermore, as shown in FIG. 10, the absorbing portion 34 is also disposed at a lower side of the organic solvent adsorbing portion 35C.

That is, the liquid absorption unit 1000 according to this embodiment includes the container 31 which recovers the waste liquid Q′, which is a liquid containing an organic solvent, introduced from the introduction portion 37 configured to introduce the waste liquid Q′; the absorbing portion 34 which is received in the container 31 and which includes the water absorbing resin 4, which is a polymer absorbent, absorbing the waste liquid Q′; and the organic solvent adsorbing portion 35C which is received in the container 31 and which adsorbs the organic solvent contained in the waste liquid Q′. In addition, the organic solvent adsorbing portion 35C is provided at a position at which the organic solvent adsorbing portion 35C comes in contact with the waste liquid Q′ before the waste liquid Q′ comes in contact with the absorbing portion 34.

According to the structure as described above, the waste liquid Q′ introduced from the introduction portion 37 first comes in contact with the organic solvent adsorbing portion 35C located at a position right under the introduction portion 37 and then comes in contact with the absorbing portion 34. That is, before coming in contact with the absorbing portion 34, the waste liquid Q′ comes in contact with the organic solvent adsorbing portion 35C. Accordingly, in the organic solvent adsorbing portion 35C, the amount of the organic solvent contained in the waste liquid Q′ can be decreased. As a result, even when the waste liquid Q′ passing through the organic solvent adsorbing portion 35C is supplied to the absorbing portion 34, the absorption amount in the absorbing portion 34 is suppressed from being decreased.

In addition, according to the liquid absorption unit 1000, the absorbing portion 34 and the organic solvent adsorbing portion 35C are both received in the container 31, and the structure is relatively simple. Hence, in terms of production easiness and production cost, the liquid absorption unit 1000 is also useful.

The introduction portion 37 introduces the waste liquid Q′ into the receiving space 313 of the container 31. As is the pipe 36 according to the first embodiment, the introduction portion 37 as described above extends from the outside of the container 31 to the receiving space 313 through the insertion hole 316 provided in the side wall portion 312 of the container 31.

At the lower side of the organic solvent adsorbing portion 35C shown in FIG. 10, as described above, the absorbing portion 34 is provided. That is, the organic solvent adsorbing portion 35C shown in FIG. 10 is disposed above the absorbing portion 34 in a vertical direction.

According to the structure as described above, when the waste liquid Q′ introduced from the introduction portion 37 spontaneously falls, the waste liquid Q′ first comes in contact with the organic solvent adsorbing portion 35C and is then likely to be transferred to the absorbing portion 34. Hence, a flow in which the waste liquid Q′ continuously introduced is transferred to the absorbing portion 34 through the organic solvent adsorbing portion 35C is likely to be formed.

In this embodiment, as shown in FIG. 11, the organic solvent adsorbing portion 35C is provided at an introduction position 374 to which the waste liquid Q′ is introduced from the introduction portion 37. In particular, the introduction position 374 is regarded as a range to which the waste liquid Q′ reaches at a moment at which the waste liquid Q′ introduced from the introduction portion 37 scatters or intrudes into gaps upon collision with the organic solvent adsorbing portion 35C. Hence, for example, as shown in FIGS. 10 and 11, the introduction position 374 indicates a predetermined range extending in an X-Y plan right under the introduction portion 37 and also indicates a predetermined depth range extending below from the above range in the vertical direction.

Since the organic solvent adsorbing portion 35C is disposed at the introduction position 374 as described above, before the waste liquid Q′ introduced from the introduction portion 37 comes in contact with the absorbing portion 34, in particular, the probability of the waste liquid Q′ to come in contact with the organic solvent adsorbing portion 35C can be increased.

In addition, as shown in FIG. 11, the absorbing portion 34 is provided at a side wall portion 312 side of the container 31 than the introduction position 374. Furthermore, as shown in FIG. 10, the absorbing portion 34 is provided at a bottom portion 311 side of the container 31 than the introduction position 374.

According to the structure as described above, when the waste liquid Q′ which comes in contact with the organic solvent adsorbing portion 35C is diffused in all directions, for example, using a capillary phenomenon as a driving force, the waste liquid Q′ thus diffused can be received in the absorbing portion 34. Accordingly, the flow of the waste liquid Q′ from the organic solvent adsorbing portion 35C to the absorbing portion 34 can be more reliably formed. As a result, the absorption amount in the absorbing portion 34 can be maximally increased.

In addition, the positional relationship between the organic solvent adsorbing portion 35C and the absorbing portion 34 is not limited to that described above. For example, the organic solvent adsorbing portion 35C may penetrate the absorbing portion 34 along the vertical axis. In addition, the organic solvent adsorbing portion 35C may partially reach the side wall portion 312.

In addition, when viewed in plan from the above, the organic solvent adsorbing portion 35C is not limited to have a square shape shown in FIG. 11 and may have a round shape, a polygonal shape, or a shape other than those mentioned above.

Furthermore, the lengths of the organic solvent adsorbing portion 35C along the X axis and the Y axis each may be constant regardless of the position along the Z axis or may be changed in accordance with the position along the Z axis.

In addition, the number of the organic solvent adsorbing portions 35C received in the container 31 is not limited to one shown in the drawing and may also be at least two.

Furthermore, the height of the upper surface of the organic solvent adsorbing portion 35C and the height of the upper surface of the absorbing portion 34 are not necessarily the same as shown in FIG. 10 and may be different from each other.

In addition, although separated from each other as shown in FIG. 10, the introduction portion 37 and the organic solvent adsorbing portion 35C may also be in contact with each other. In the latter case, the range of the organic solvent adsorbing portion 35C in the X-Y plan can be decreased as compared to that in the former case. Hence, corresponding to the decrease in the range, the volume of the absorbing portion 34 can be increased.

For example, as is the case of the organic solvent adsorbing portion 35 according to the first embodiment, the organic solvent adsorbing portion 35C includes an adsorbent. This adsorbent is similar to the adsorbent 354 of the first embodiment. In addition, as is the first embodiment, the form of the adsorbent of the organic solvent adsorbing portion 35C may be, for example, particles, fibers, clumps, cloths, or the like.

In this embodiment, the absorbing portion 34 is also formed of the aggregate of the small pieces 2 shown in FIGS. 2 and 3. As shown in FIGS. 2 and 3, the small pieces 2 each preferably include the base material 5 which contains cellulose fibers and the water absorbing resin 4, which is a polymer absorbent, supported by this base material 5.

According to the structure as described above, an effect in that when being received in the container 31, the absorbing portion 34 is deformed in accordance with the shape of the receiving space 313 and is smoothly received therein and an effect in that the waste liquid Q′ is efficiently permeated in the base material 5 and is efficiently absorbed by the water absorbing resin 4 can be obtained at the same time. In addition, since the absorbing portion 34 as described above is formed using a natural derived material, such as a cellulose, the support property of the water absorbing resin 4 by the base material 5 is excellent, and an effect to contribute to the reduction of environmental load may also be obtained.

In this embodiment, when the water absorbing resin 4, which is a polymer absorbent, includes an anionic water absorbing resin, the organic solvent adsorbing portion 35C preferably contains active carbon. Since the active carbon is used, of the organic solvents, in particular, an organic solvent having a composition which is liable to disturb the absorption of the waste liquid Q′ in the anionic water absorbing resin is likely to be adsorbed by the active carbon. Hence, even when a dye ink containing a relatively large amount of an organic solvent is recovered as a waste liquid, the organic solvent thereof can be removed by the organic solvent adsorbing portion 35C. As a result, in the absorbing portion 34, the disturbance of the absorption caused by the organic solvent is not likely to occur, and a sufficient amount of the waste liquid Q′ can be absorbed in the absorbing portion 34.

In addition, in this embodiment, as is the case of the first embodiment, of the organic solvents, in particular, an organic solvent having an SP value of 10 or less is also liable to disturb the absorbing characteristics of the water absorbing resin 4. In consideration of the fact described above, the organic solvent adsorbing portion 35C preferably adsorbs the organic solvent having an SP value of 10 or less. Since the organic solvent adsorbing portion 35C as described above is used, in particular, the absorbing characteristics of the water absorbing resin 4 can be suppressed from being degraded.

Furthermore, in this embodiment, as the organic solvent adsorbing portion 35C, although any member capable of adsorbing the organic solvent having an SP value of 10 or less may be used, a member having the following performance is preferable.

When the waste liquid Q′ which is a liquid before coming in contact with the organic solvent adsorbing portion 35C contains an organic solvent having an SP value of 10 or less at a first content of 2 percent by mass or more, the waste liquid Q′ after coming in contact with the organic solvent adsorbing portion 35C contains the organic solvent having an SP value of 10 or less preferably at a content of less than the first content and 3 percent by mass or less and more preferably at a content of less than the first content and 2 percent by mass or less.

Since the organic solvent adsorbing portion 35C has the adsorbing performance as described above, the absorption amount of the waste liquid Q′ in the absorbing portion 34 can be sufficiently secured. In other words, since the organic solvent having an SP value of 10 or less acts on the absorbing portion 34, the absorption of the waste liquid Q′ in the absorbing portion 34 is disturbed; however, according to this embodiment, the disturbance described above can be sufficiently suppressed. Hence, a designed absorption amount can be realized in the absorbing portion 34.

In the second embodiment as described above, an effect similar to that of the first embodiment or its modified example may also be obtained.

### 6. Fourth Modified Example

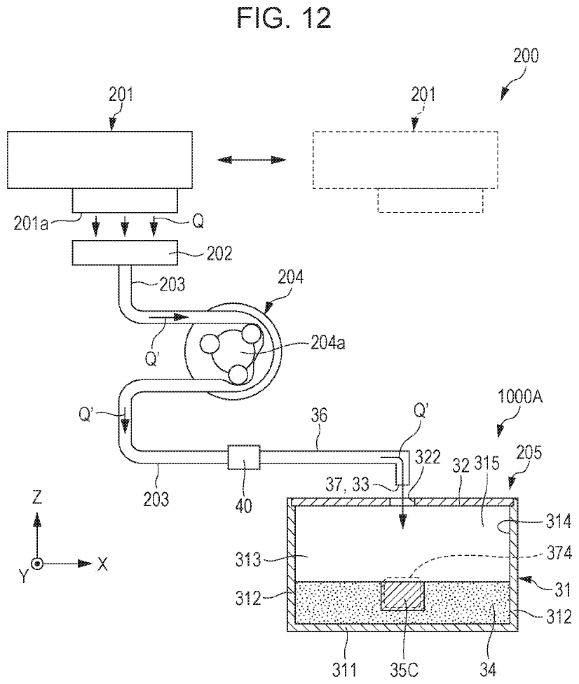

FIG. 12 is a partially vertical cross-sectional view showing a liquid absorption unit 1000A according to a fourth modified example.

Hereinafter, although the fourth modified example will be described, in the following description, points different from the second embodiment will be mainly described, and description of matters similar to those of the second embodiment will be omitted. In addition, in FIG. 12, a constituent element similar to that of the second embodiment will be designated by the same reference numeral.

The liquid absorption unit 1000A according to the fourth modified example is similar to the liquid absorption unit 1000 according to the second embodiment except for the position of the introduction portion 37.

In the liquid absorption unit 1000 according to the second embodiment described above, the introduction portion 37 is located in the receiving space 313 of the container 31. On the other hand, in the liquid absorption unit 1000A according to the fourth modified example, the introduction portion 37 is provided outside of the container 31.

In addition, a lid 32 shown in FIG. 12 has a waste liquid passing opening 322 penetrating along the Z axis. In addition, the positions of the introduction portion 37 and the lid 32 are set so that a waste liquid Q′ which drips from the introduction portion 37 passes through the waste liquid passing opening 322.

According to the structure as described above, since the container 31 and the introduction portion 37 can be separated from each other, in particular, an exchange operation of the container 31 in which the absorbing portion 34 is received can be easily performed.

In the fourth modified example as described above, an effect similar to that of the second embodiment may also be obtained.

In addition, the image forming apparatus 200 according to this embodiment includes the liquid absorption system 100, 100A, or 100B described above or the liquid absorption unit 1000 or 1000A described above.

According to the image forming apparatus 200 as described above, for example, even when a dye ink containing a relatively large amount of an organic solvent is used, the absorption amount in the absorbing portion 34 is not likely to be decreased, and a sufficient amount of the waste liquid Q′ can be absorbed. Accordingly, since a practical absorption amount of the absorbing portion 34 can be increased, maintenance intervals can be increased, and as a result, an easy-to-use image forming apparatus 200 can be realized.

Heretofore, although the liquid absorption system, the liquid absorption unit, and the image forming apparatus have been described with reference to the embodiments using the drawings, the present disclosure is not limited thereto, and constituent elements forming the liquid absorption system, the liquid absorption unit, and the image forming apparatus each may be replaced with an arbitrary element having a sufficient function similar to that described above. In addition, an arbitrary constituent element may also be added to those described above.

In addition, the liquid absorption system and the liquid absorption unit of the present disclosure may be used to absorb, besides the waste ink liquid, any types of liquids.

Furthermore, the liquid absorption systems and the liquid absorption units according to the embodiments described above each may be used, for example, as an “ink leakage receiver” to absorb an ink which unintentionally leaks from an ink flow path of an image forming apparatus.

### EXAMPLES

Next, concrete examples of the present disclosure will be described.

### 7. Formation of Liquid Absorption System (First Evaluation Example)

### Example A1

In Example A1, the liquid absorption system shown in FIG. 1 was formed. In addition, the organic solvent adsorbing portion and the absorbing portion of the liquid absorption system were formed as described below.

First, as the organic solvent adsorbing portion, a container and active carbon to be received in the container were prepared. As the active carbon, Kuraray Coal KW10/32 manufactured by Kuraray Co., Ltd. was used.

In addition, as the absorbing portion, an urethane foam containing a water absorbing resin which was similar to that described in Example 1 of JP-A-2007-8126 was used.

### Example A2

A liquid absorption system was formed in a manner similar to that of Example A1 except for that as the active carbon, Shirasagi M manufactured by Osaka Gas Chemicals Co., Ltd. was used.

### Example A3

A liquid absorption system was formed in a manner similar to that of Example A1 except for that as the active carbon, Shirasagi DO-5 manufactured by Osaka Gas Chemicals Co., Ltd. was used.

### Example A4

A liquid absorption system was formed in a manner similar to that of Example A1 except for that as the active carbon, Kuraray Coal GW10/32 manufactured by Kuraray Co., Ltd. was used.

### Example A5

A liquid absorption system was formed in a manner similar to that of Example A1 except for that as the absorbing portion, a vinyl lactam-based cross-linked polymer similar to that disclosed in production example 1 of JP-A-2018-43516.

### Comparative Example A

A liquid absorption system was formed in a manner similar to that of Example A1 except for that the organic solvent adsorbing portion was omitted.

### 8. Evaluation of Liquid Absorption System (First Evaluation Example)

### 8.1. Preparation of Evaluation Ink

An evaluation ink to be used for evaluation of the liquid absorption system was prepared as described below.

First, as inks for an ink jet printer manufactured by Seiko Epson Corporation, MKA-BK, HNA-PB, HNA-C, HNA-M, and HNA-Y were weighed so that the amounts thereof were equivalent to each other on a mass basis.

Next, the inks mentioned above were mixed together, so that a mixed ink was prepared. Accordingly, the evaluation ink was obtained.

### 8.2. Evaluation of Absorbing Rate

The absorbing portion of each liquid absorption system was taken out, and test pieces were formed therefrom.

Subsequently, the evaluation ink was allowed to pass through the organic solvent adsorbing portion and the discharge portion of each liquid absorption system.

Next, 1 cc of the evaluation ink thus passing was allowed to drip on the test piece. Subsequently, a time required for the absorption of the evaluation ink thus dripping in the test piece was measured. In addition, the time thus measured was evaluated with reference to the following evaluation criteria.

### Evaluation Criteria of Absorbing Rate

A: Whole amount was absorbed in less than 5 seconds.

B: Whole amount was absorbed in 5 to less than 10 seconds.

C: Whole amount was absorbed in 10 seconds or more.

The evaluation results are shown in Table 1.

### 8.3. Evaluation of Absorption Amount

The absorbing portion of each liquid absorption system was taken out, and test pieces were formed therefrom. In addition, the test pieces each had a length of 10 cm, a width of 10 cm, and a thickness of 1 cm.

Next, the evaluation ink was allowed to pass through the organic solvent adsorbing portion and the discharge portion of each liquid absorption system. In addition, the test piece was entirely dipped in the evaluation ink thus passing.

Next, the test piece dipped in the evaluation ink was recovered and was then left for 30 minutes while being hanged in air. After the test piece was left, the mass thereof was measured, and an increased mass from the mass of the test piece before the test was calculated as the ink absorption amount. In addition, the ink absorption amount thus calculated was evaluated with reference to the following evaluation criteria.

### Evaluation Criteria of Absorption Amount

A: Absorption amount of 100 g or more

B: Absorption amount of 50 to less than 100 g

C: Absorption amount of less than 50 g

The evaluation results are shown in Table 1.

TABLE 1

| | STRUCTURE OF LIQUID | | | |
|---|---|---|---|---|
| | ABSORPTION SYSTEM | | | |
| | ORGANIC | | | |
| | SOLVENT | | EVALUATION RESULT | |
| | ADSORBING | ABSORBING | ABSORBING | ABSORPTION |
| | PORTION | PORTION | RATE | AMOUNT |
| EXAMPLE A1 | ACTIVE | WATER | A | A |
| | CARBON | ABSORBING | | |
| | (KW10/32) | RESIN- | | |
| | | CONTAINING | | |
| | | URETHANE | | |
| | | FOAM | | |
| EXAMPLE A2 | ACTIVE | WATER | A | A |
| | CARBON | ABSORBING | | |
| | (SHIRASAGI | RESIN- | | |
| | M) | CONTAINING | | |
| | | URETHANE | | |
| | | FOAM | | |
| EXAMPLE A3 | ACTIVE | WATER | A | A |
| | CARBON | ABSORBING | | |
| | (SHIRASAGI | RESIN- | | |
| | DO-5) | CONTAINING | | |
| | | URETHANE | | |
| | | FOAM | | |
| EXAMPLE A4 | ACTIVE | WATER | A | A |
| | CARBON | ABSORBING | | |
| | (GW10/32) | RESIN- | | |
| | | CONTAINING | | |
| | | URETHANE | | |
| | | FOAM | | |
| EXAMPLE A5 | ACTIVE | VINYL LACTAM- | B | B |
| | CARBON | BASED CROSS- | | |
| | (KW10/32) | LINKED | | |
| | | POLYMER | | |
| COMPARATIVE | — | WATER | C | C |
| EXAMPLE A | | ABSORBING | | |
| | | RESIN- | | |
| | | CONTAINING | | |
| | | URETHANE | | |
| | | FOAM | | |

As apparent from Table 1, as for the evaluation ink passing through the organic solvent adsorbing portion of the liquid absorption system of each of the examples, a sufficient amount could be absorbed in the absorbing portion at a sufficient rate. On the other hand, in the comparative example, the ink absorbing rate and the absorption amount in the absorbing portion were insufficient. The reason for this is believed that the organic solvent adsorbing portion was omitted.

### 9. Formation of Liquid Absorption System (Second Evaluation Example)

### Example B1

In Example B1, the liquid absorption system shown in FIG. 1 was prepared. In addition, the organic solvent adsorbing portion and the absorbing portion of the liquid absorption system were formed as described below.

First, as the organic solvent adsorbing portion, a container and active carbon to be received in the container were prepared. As the active carbon, Kuraray Coal KW10/32 manufactured by Kuraray Co., Ltd. was used.

In addition, the absorbing portion was formed as described below.

First, as a sheet-shaped fiber base material, G80A4W which was old paper, manufactured by Toppan Forms Co., Ltd., having a length of 30 cm, a width of 22 cm, and a thickness of 0.5 mm was prepared. In addition, the weight of the paper was 4 g/piece.

Next, 2 g of purified water was applied on one side surface of this old paper by spraying.

Subsequently, as a poly(acrylic acid) cross-linked polymer which was a water absorbing resin having a carboxy group as an acid group on its side chain, Sunfresh 500MPSA (manufactured by Sanyo Chemical Industries, Ltd.) was applied on one side surface of the old paper. In this step, the water absorbing resin was applied while being allowed to pass through a sieve (JTS-200-45-106, manufactured by Tokyo Screen Co., Ltd.) with meshes each having an opening dimension of 0.106 mm. The application amount of the water absorbing resin per one old paper was 3 g. In addition, the old paper was folded in half so that the surface to which the water absorbing resin was adhered had a valley shape. In this folded state, the sheet-shaped fiber base material was heated and pressurized in a thickness direction using a pair of heating blocks. The pressure application was performed at 0.15 kg/cm² and the heating temperature was 100° C. In addition, a time for the heat application and the pressure application was 120 seconds. In addition, after the heat application and the pressure application were released, the sheet-shaped fiber base material was left for 12 hours at room temperature, so that the temperature thereof was decreased to ordinary temperature.

Subsequently, the sheet-shaped fiber base material was cut into pieces each having a rectangular shape with a width of 2 mm and a length of 15 mm using a shredder (SeCuret Series F3143SP, manufactured by Ishizawa Seisakusho Co., Ltd.) having a standard shred size of 2 mm by 15 mm. Accordingly, an aggregate of small pieces was obtained.

The content of the water absorbing resin in the small piece was 75 percent by mass with respect to the fibers, and the average particle diameter of the water absorbing resin was 35 to 50 μm. In addition, in the small piece, the water absorbing resin was impregnated in the fiber base material. Subsequently, the small pieces were placed in a paper bag and then vibrated for 60 seconds, so that the small pieces were deformed. The small pieces thus obtained were received in the container, so that the liquid absorption system was obtained.

### Example B2

A liquid absorption system was formed in a manner similar to that of Example B1 except for that as the active carbon, Shirasagi M manufactured by Osaka Gas chemicals Co., Ltd. was used.

### Example B3

A liquid absorption system was formed in a manner similar to that of Example B1 except for that as the active carbon, Shirasagi DO-5 manufactured by Osaka Gas chemicals Co., Ltd. was used.

### Example B4

A liquid absorption system was formed in a manner similar to that of Example B1 except for that as the active carbon, Kuraray Coal GW10/32 manufactured by Kuraray Co., Ltd. was used.

### Example B5

A liquid absorption system was formed in a manner similar to that of Example B1 except for that instead of the active carbon, Nikka gel S-65 manufactured by Toshin Chemicals Co., Ltd., which was a silica alumina gel, was used.

### Example B6

A liquid absorption system was formed in a manner similar to that of Example B1 except for that instead of the active carbon, SP-700 manufactured by Mitsubishi Chemical Corporation, which was an aromatic synthetic adsorbent, was used.

### Comparative Example B

Except for that the organic solvent adsorbing portion was omitted, a liquid absorption system was formed in a manner similar to that of Example B1.

### 10. Evaluation of Liquid Absorption System (Second Evaluation Example)

### 10.1 Preparation of Evaluation Ink

An evaluation ink to evaluate the liquid absorption system was prepared as described below.

First, six types of materials shown in the following Table 2 were mixed together. A mixing rate was as shown in Table 2. In addition, in Table 2, the SP value of each material is shown.

TABLE 2

| | | | | TRIETHYLENE | | |
|---|---|---|---|---|---|---|
| | | | | GLYCOL | | |
| | C.I.Acid | | TRIETHYLENE | MONOBUTYL | OLFINE | DISTILLED |
| | Red 92 | GLYCERIN | GLYCOL | ETHER | E1010 | WATER |
| SP VALUE | — | 16.5 | 12.1 | 9.8 | 9.8 | 23.4 |
| MIXING | 6 | 5 | 3 | 10 | 1 | 75 |
| RATE | | | | | | |
| [PERCENT | | | | | | |
| BY MASS] | | | | | | |

### 10.2 Evaluation of Absorption Amount

The absorbing portions of the liquid absorption systems were taken out in amounts equivalent to each other, and evaluation small-piece groups were obtained therefrom.

Next, the evaluation ink was allowed to pass through the organic solvent adsorbing portion and the discharge portion of each liquid absorption system. In addition, the evaluation ink thus passing was absorbed in the evaluation small-piece group.

After the evaluation small-piece group was left for 30 minutes, the ink amount not absorbed in the evaluation small-piece group was measured, and the ink absorption amount was calculated. In addition, the ink absorption amount thus calculated was evaluated in accordance with the following evaluation criteria.

### Evaluation Criteria of Absorption Amount

A: Absorption amount is relatively large.

B: Absorption amount is relatively small.

C: Absorption amount is relatively very small.

The evaluation results are shown in FIG. 3.

TABLE 3

| | STRUCTURE OF LIQUID ABSORPTION | | |
|---|---|---|---|
| | SYSTEM | | |
| | ORGANIC | | EVALUATION |
| | SOLVENT | | RESULT |
| | ADSORBING | | ABSORPTION |
| | PORTION | ABSORBING PORTION | AMOUNT |
| EXAMPLE B1 | ACTIVE CARBON | AGGREGATE OF SMALL | A |
| | (KW10/32) | PIECES CONTAINING | |
| | | WATER ABSORBING | |
| | | RESIN | |
| EXAMPLE B2 | ACTIVE CARBON | AGGREGATE OF SMALL | A |
| | (SHIRASAGI M) | PIECES CONTAINING | |
| | | WATER ABSORBING | |
| | | RESIN | |
| EXAMPLE B3 | ACTIVE CARBON | AGGREGATE OF SMALL | A |
| | (SHIRASAGI DO-5) | PIECES CONTAINING | |
| | | WATER ABSORBING | |
| | | RESIN | |
| EXAMPLE B4 | ACTIVE CARBON | AGGREGATE OF SMALL | A |
| | (GW10/32) | PIECES CONTAINING | |
| | | WATER ABSORBING | |
| | | RESIN | |
| EXAMPLE B5 | SILICAALUMINA | AGGREGATE OF SMALL | B |
| | GEL (NIKKAGEL | PIECES CONTAINING | |
| | S-65) | WATER ABSORBING | |
| | | RESIN | |
| EXAMPLE B6 | AROMATIC | AGGREGATE OF SMALL | B |
| | SYNTHETIC | PIECES CONTAINING | |
| | ADSORBENT | WATER ABSORBING | |
| | (SP-700) | RESIN | |
| COMPARATIVE | — | AGGREGATE OF SMALL | C |
| EXAMPLE B | | PIECES CONTAINING | |
| | | WATER ABSORBING | |
| | | RESIN | |

As apparent from Table 3, the evaluation ink passing through the organic solvent adsorbing portion of the liquid absorption system of each example could be absorbed in a sufficient amount in the absorbing portion. In particular, when the organic solvent adsorbing portion contained active carbon as the adsorbent, the tendency described above was significant. On the other hand, in the comparative example, the ink absorption amount in the absorbing portion was insufficient. The reason for this is believed that the organic solvent adsorbing portion was omitted.

What is claimed is:

1. A liquid absorption system comprising:
a pipe which transports a liquid containing an organic solvent;
a discharge portion which discharges the liquid transported by the pipe;
a container which recovers the liquid discharged from the discharge portion;
an absorbing portion which is received in the container and which includes a polymer absorbent absorbing the liquid; and
an organic solvent adsorbing portion which adsorbs the organic solvent contained in the liquid,
wherein the organic solvent adsorbing portion is provided at a position at which the organic solvent adsorbing portion comes in contact with the liquid before the liquid comes in contact with the absorbing portion.

2. The liquid absorption system according to claim 1,
wherein the organic solvent adsorbing portion is provided at the pipe or the discharge portion or between the pipe and the discharge portion.

3. The liquid absorption system according to claim 1,
wherein the organic solvent adsorbing portion adsorbs an organic solvent having an SP value of 10 or less.

4. The liquid absorption system according to claim 3,
wherein the liquid before coming in contact with the organic solvent adsorbing portion contains an organic solvent having an SP value of 10 or less at a first content of 2 percent by mass or more, and
in the liquid after coming in contact with the organic solvent adsorbing portion, a content of the organic solvent having an SP value of 10 or less is less than the first content and is 3 percent by mass or less.

5. The liquid absorption system according to claim 1,
wherein the absorbing portion is formed of an aggregate of small pieces each of which includes a base material containing cellulose fibers and the polymer absorbent supported by the base material.

6. The liquid absorption system according to claim 1,
wherein the polymer absorbent contains an anionic water absorbing resin, and
the organic solvent adsorbing portion contains active carbon.

7. A liquid absorption unit comprising:
a container which recovers a liquid containing an organic solvent introduced from an introduction portion configured to introduce the liquid;
an absorbing portion which is received in the container and which includes a polymer absorbent absorbing the liquid; and
an organic solvent adsorbing portion which is received in the container and which adsorbs the organic solvent contained in the liquid,
wherein the organic solvent adsorbing portion is provided at a position at which the organic solvent adsorbing portion comes in contact with the liquid before the liquid comes in contact with the absorbing portion.

8. The liquid absorption unit according to claim 7,
wherein the organic solvent adsorbing portion is disposed above the absorbing portion in a vertical direction.

9. The liquid absorption unit according to claim 7,
wherein the organic solvent adsorbing portion is provided at an introduction position at which the liquid is introduced from the introduction portion, and
the absorbing portion is provided at a side wall side or a bottom portion side of the container than the introduction position.

10. The liquid absorption unit according to claim 7,
wherein the organic solvent adsorbing portion adsorbs an organic solvent having an SP value of 10 or less.

11. The liquid absorption unit according to claim 10,
wherein the liquid before coming in contact with the organic solvent adsorbing portion contains an organic solvent having an SP value of 10 or less at a first content of 2 percent by mass or more, and
in the liquid after coming in contact with the organic solvent adsorbing portion, a content of the organic solvent having an SP value of 10 or less is less than the first content and is 3 percent by mass or less.

12. The liquid absorption unit according to claim 7,
wherein the absorbing portion is formed of an aggregate of small pieces each of which includes a base material containing cellulose fibers and the polymer absorbent supported by the base material.

13. The liquid absorption unit according to claim 7,
wherein the polymer absorbent contains an anionic water absorbing resin, and
the organic solvent adsorbing portion contains active carbon.

14. An image forming apparatus comprising:
one of the liquid absorption system according to claim 1 and the liquid absorption unit according to claim 7.
